(19) United States
(12) Patent Application Publication
(10) Pub. No.: US 2013/0198381 A1
(43) Pub. Date: Aug. 1, 2013

(54) Optimizing Data Extraction from Distributed Systems into a Unified Event Aggregator Using Time-Outs

(71) Applicants: Niall Caffrey, Dublin (IE); Bill Looby, Dublin (IE); Javier Rodriguez, Dublin (IE); Kris Vishwanathan, Cary, NC (US)

(72) Inventors: Niall Caffrey, Dublin (IE); Bill Looby, Dublin (IE); Javier Rodriguez, Dublin (IE); Kris Vishwanathan, Cary, NC (US)

(73) Assignee: International Business Machines Corporation, Armonk, NY (US)

(21) Appl. No.: 13/361,846

(22) Filed: Jan. 30, 2012

(51) Int. Cl. G06F 15/173

(52) U.S. Cl. 709/225

(57) ABSTRACT

Methods and systems of managing automated feed retrieval systems may involve determining an inactivity period with respect to a feed source, and identifying a user time-out threshold corresponding to the feed source. In addition, a re-subscription prompt may be generated if the inactivity period exceeds the user time-out threshold. In one example, a user may be unsubscribed from the feed source if a confirmation response to the re-subscription prompt is not received from the user. Moreover, data retrieval from the feed source can be discontinued if the feed source lacks any remaining subscribers in the automated feed retrieval system.

### BACKGROUND

Embodiments of the present invention generally relate to back-end systems for feed aggregators. More particularly, embodiments relate to the use of time-outs to automatically discontinue data retrieval from aggregator feed sources.

Online content may be syndicated by various content producers in the form of social networking activity streams, RSS (Resource Description Framework/RDF Site Summary) feeds, Atom feeds, other event based activity streams, etc., wherein feed aggregators can enable users to subscribe to feeds from different content producers and display the data together. It may not be uncommon for users to subscribe to certain feeds and rarely, if ever, actually interact with those feeds. In such a case, a back-end system may be configured to automatically retrieve data from feed sources although the data is not being read by any subscribers associated with the back-end system. Accordingly, performance bottlenecks may result, particularly in enterprise scenarios in which support for a large number of users and/or subscriptions may lead to large volumes of feed data.

### BRIEF SUMMARY

Embodiments may include a computer program product having a computer readable storage medium and computer usable code stored on the computer readable storage medium. If executed by a processor, the computer usable code may cause a computer to determine an inactivity period with respect to a feed source, and identify a user time-out threshold corresponding to the feed source. The computer usable code may also cause a computer to generate a re-subscription prompt if the inactivity period exceeds the time-out threshold.

Embodiments may also include a computer implemented method in which an inactivity period is determined with respect to a feed source, and a user time-out threshold corresponding to the feed source is identified. The method may also provide for generating a re-subscription prompt if the inactivity period exceeds the user time-out threshold. In addition, a user may be re-subscribed to the feed source if a confirmation response to the re-subscription prompt is received from the user. If, on the other hand, a confirmation response to the re-subscription prompt is not received from the user, the method may provide for unsubscribing the user from the feed source. Moreover, data retrieval from the feed source may be discontinued if the feed source lacks any remaining subscribers in an automated feed retrieval system. Discontinuing the data retrieval can include deleting a feed handler plug-in associated with the feed source, wherein discontinuing the data retrieval may reduce a network demand associated with the automated feed retrieval system.

Embodiments may also include a computer program product having a computer readable storage medium and computer usable code stored on the computer readable storage medium. If executed by a processor, the computer usable code may cause a computer to determine an inactivity period with respect to a feed source, and identify a user time-out threshold corresponding to the feed source. Additionally, the computer usable code can cause a computer to generate a re-subscription prompt if the inactivity period exceeds the user time-out threshold, and re-subscribe a user to the feed source if a confirmation response to the re-subscription prompt is received from the user. If, on the other hand, a confirmation response to the re-subscription prompt is not received from the user, the computer usable code may cause a computer to unsubscribe the user from the feed source. The computer usable code can also cause a computer to discontinue data retrieval from the feed source if the feed source lacks any remaining subscribers in an automated feed retrieval system. Discontinuing the data retrieval may include a deletion of a feed handler plug-in associated with the feed source and a reduction of a network demand associated with the automated feed retrieval system.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of an automated feed retrieval system according to an embodiment;

FIG. 2A is a flowchart of an example of a method of conducting a time-out analysis according to an embodiment;

FIG. 2B is a flowchart of an example of a method of optimizing data extraction from feed sources according to an embodiment; and

FIG. 3 is a block diagram of a networking architecture according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

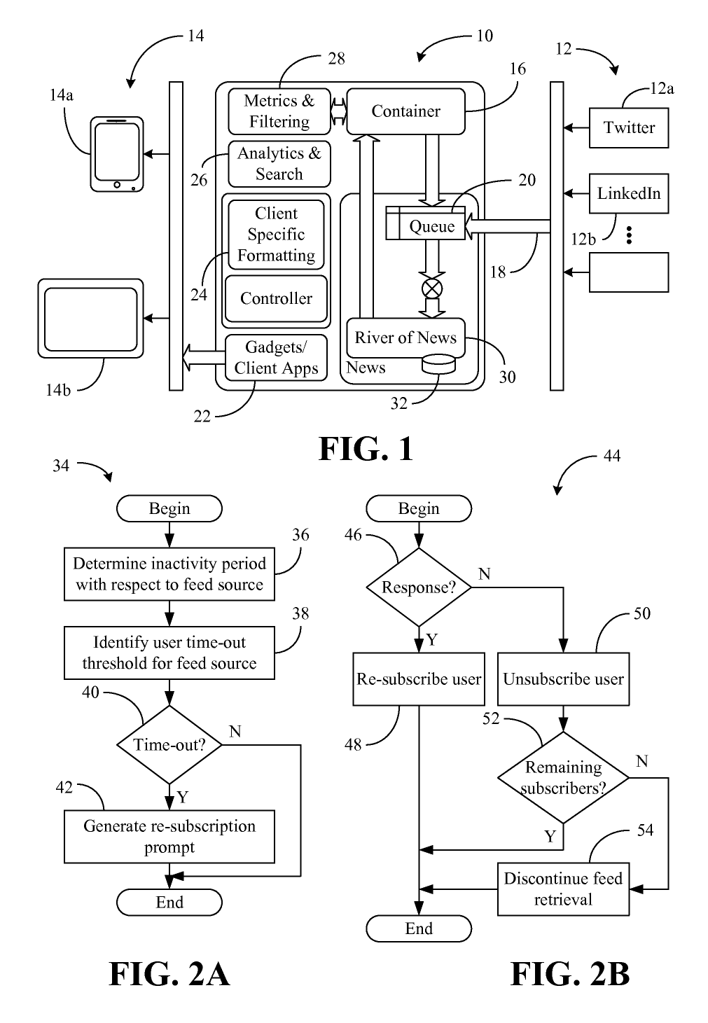

Referring now to FIG. 1, an automated feed retrieval system 10 is shown, wherein the system 10 is capable of extracting data from multiple feed sources 12 (12a, 12b), and providing the extracted data to subscribers via devices 14 (14a, 14b). Generally, the feed retrieval system 10 may aggregate data from the feed sources 12 (e.g., using feed handler plug-ins) and populate one or more feed aggregator containers 16 with the aggregated data. In the illustrated example, the feed retrieval system 10 monitors various activity streams 18 associated with the feed sources 12, wherein the activity streams 18 may provide a mechanism to communicate events of interest to end users of the subscriber devices 14. An event may be considered a notable occurrence in an application that may be deemed worthy of the attention of a user who is following the affected object. Such an event may be referred to as an “activity” in social networking terms.

In particular, a queue 20 may accumulate data and/or events from the activity streams 18, wherein the accumulated information may be filtered and otherwise modified via various subscriber front-end tools such as client applications 22, formatting tools 24, analytics and search tools 26, metrics and filtering tools 28, and so forth. The result may be a “river of news” output 30 that can be stored and/or tracked in a database 32 or other suitable storage solution. As will be discussed in greater detail, the illustrated feed retrieval system 10 may reduce the network demand associated with extracting information from the activity streams 18 by automatically recognizing stale feed subscriptions and discontinuing data retrieval from the feed sources corresponding to those subscriptions.

FIG. 2A shows a method 34 conducting a time-out analysis for a feed aggregator architecture. The illustrated method 34 may be implemented in a back-end system such as the automated feed retrieval system 10 (FIG. 1), already discussed, wherein the system may support a relatively large number of users and/or feed subscriptions. Generally, the method 34 could be conducted on a per feed source, per user basis. In particular, processing block 36 may provide for determining an inactivity period with respect to the feed source. Determining the inactivity period can involve, for example, identifying the last time the user in question interacted with data from the feed source (e.g., the “last access date” associated with the feed source) and comparing the last access date to the current date. For example, it might be determined at block 36 that data from the feed source was last accessed by the user thirty-two days ago.

Illustrated block 38 identifies a user time-out threshold for the feed source, wherein the user time-out threshold may be a system-wide value, user configurable (e.g., stored in a user profile), and so forth. For example, the user time-out threshold might be thirty days. A determination may therefore be made at block 40 as to whether the inactivity period exceeds the user time-out threshold. If so, a re-subscription prompt can be generated at block 42. The re-subscription prompt may be presented to the user in an effort to confirm the user's continuing interest in the feed source. Thus, the prompt might include a message such as “It has been over thirty days since you accessed feed XYZ. Please confirm that you would like to continue your subscription.” The prompt may be communicated to the user via a web interface, text message, instant messaging (IM) interface or other suitable interface. The method 34 may be repeated for each user of a feed source, and for each feed source from which data is retrieved.

Turning now to FIG. 2B, a method 44 of optimizing data extraction from feed sources is shown. The illustrated method 44, which may also be implemented in a back-end system such as the automated feed retrieval system 10 (FIG. 1), can be conducted on a per outstanding re-subscription prompt basis. In particular, block 46 provides for determining whether a confirmation response to a re-subscription prompt has been received from a particular user. The confirmation response may be a simple affirmative response or a more complex response such as a user configuration of a specific time-out threshold. If the confirmation response has been received, block 48 may re-subscribe the user to the feed source by, for example, resetting the last access date to the current date, extending the user time-out threshold, etc. If a confirmation response to the re-subscription prompt has not been received from the user, illustrated block 50 unsubscribes the user from the feed source.

In addition, block 52 may determine whether the feed source in question has any remaining subscribers. If not, feed retrieval from the feed source may be discontinued at block 54. In one example, discontinuing the feed retrieval involves deleting a feed handler plug-in associated with the feed source. The use of feed handler plug-ins can facilitate the process of optimizing data extraction by providing a high level of modularity, which can make the system more scalable. Moreover, discontinuing the feed retrieval may reduce the network demand associated with the automated feed retrieval system. The method 44 may be repeated for each outstanding re-subscription prompt, as already noted.

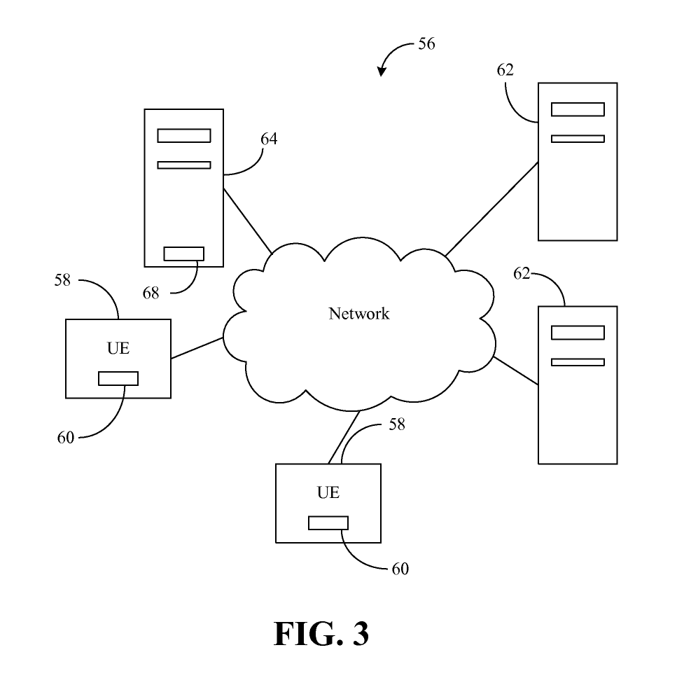

FIG. 3 shows a networking architecture 56 in which user equipment (UE) devices 58 include a feed aggregator 60 that receives feed data originating from sources on servers 62. In the illustrated example, a server 64, which functions as an automated feed retrieval system, automatically retrieves data from the feed sources on the servers 62 via a network 66, and provides the feed data to the UE devices 58 according to individual user subscription settings. The network 66 can itself include any suitable combination of servers, access points, routers, base stations, mobile switching centers, public switching telephone network (PSTN) components, etc., to facilitate communication between the UE devices 60 and servers 62, 64. In one example, the server 64 includes logic 68 to determine inactivity periods with respect to feed sources, identify user time-out thresholds corresponding to the feed sources, and generate re-subscription prompts if the inactivity periods exceed one or more of the user time-out thresholds, as already discussed. Moreover, the illustrated logic 68 can discontinue data retrieval from the feed sources if the feed sources lack any remaining subscribers in the automated feed retrieval system.

Thus, techniques described herein may provide a framework based on a pluggable architecture that facilitates the aggregation of data from one or many sources into one or more containers. The framework can provide all services needed to handle communication with and integration of feed sources and containers. In one example, the framework runs on an application server as a background task that pulls feeds from third party sources, maps the feeds to standard events, and posts the events to one or more user configurable containers.

More particularly, the framework can enable events to be persisted into a database, wherein an appropriate API (application programming interface) may be used to configure the framework to support user profiles, etc. Additionally, high availability and error handling/recovery can be achieved, particularly in view of the ability to reduce network demand. The framework may also provide a standard events definition and a pluggable architecture in which handlers map to standard interfaces. Moreover, the framework can monitor the system and check how often events are generated, detecting time-outs when users are not interacting with third party sources. In addition, feed refresh intervals may be monitored in real-time and used to calculate how often feeds should be pulled. If the framework changes a setting or an error occurs, techniques described herein may also generate internal events and deliver them to the user.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
determining an inactivity period with respect to a feed source;
identifying a user time-out threshold corresponding to the feed source;
generating a re-subscription prompt if the inactivity period exceeds the user time-out threshold;
re-subscribing a user to the feed source if a confirmation response to the re-subscription prompt is received from the user;
unsubscribing the user from the feed source if the confirmation response to the re-subscription prompt is not received from the user; and
discontinuing data retrieval from the feed source if the feed source lacks any remaining subscribers in an automated feed retrieval system, wherein discontinuing the data retrieval includes deleting a feed handler plug-in associated with the feed source and reduces a network demand associated with the automated feed retrieval system.

2. The method of claim 1, wherein determining the inactivity period includes:
identifying a last access date associated with the feed source; and
comparing the last access data to a current date.

3. The method of claim 1, wherein identifying the user time-out threshold includes accessing a user profile.

4. The method of claim 1, further including:
aggregating data from a plurality of feed sources; and
populating one or more feed aggregator containers with the aggregated data.

5. The method of claim 4, wherein the data is aggregated from the plurality of feed sources via a network connection.

6. A computer program product comprising:
a computer readable storage medium; and
computer usable code stored on the computer readable storage medium, where, if executed by a processor, the computer usable code causes a computer to:
determine an inactivity period with respect to a feed source;
identify a user time-out threshold corresponding to the feed source;
generate a re-subscription prompt if the inactivity period exceeds the user time-out threshold;
re-subscribe a user to the feed source if a confirmation response to the re-subscription prompt is received from the user;
unsubscribe the user from the feed source if the confirmation response to the re-subscription prompt is not received from the user; and
discontinue data retrieval from the feed source if the feed source lacks any remaining subscribers in an automated feed retrieval system, wherein discontinuing the data retrieval is to include a deletion of a feed handler plug-in associated with the feed source and a reduction of a network demand associated with the automated feed retrieval system.

7. The computer program product of claim 6, wherein the computer usable code, if executed, causes a computer to:
identify a last access date associated with the feed source; and
compare the last access date to a current date.

8. The computer program product of claim 6, wherein the computer usable code, if executed, causes a computer to access a user profile to identify the user time-out threshold.

9. The computer program product of claim 6, wherein the computer usable code, if executed, causes a computer to:
aggregate data from a plurality of feed sources; and
populate one or more feed aggregator containers with the aggregated data.

10. The computer program product of claim 9, wherein the data is to be aggregated from the plurality of feed sources via a network connection.

11. A computer program product comprising:
a computer readable storage medium; and
computer usable code stored on the computer readable storage medium, where, if executed by a processor, the computer usable code causes a computer to:
determine an inactivity period with respect to a feed source;
identify a user time-out threshold corresponding to the feed source; and
generate a re-subscription prompt if the inactivity period exceeds the user time-out threshold.

12. The computer program product of claim 11, wherein the computer usable code, if executed, causes a computer to unsubscribe a user from the feed source if a confirmation response to the re-subscription prompt is not received from the user.

13. The computer program product of claim 12, wherein the computer usable code, if executed, causes a computer to discontinue data retrieval from the feed source if the feed source lacks any remaining subscribers in an automated feed retrieval system.

14. The computer program product of claim 13, wherein discontinuing the data retrieval from the feed source is to reduce a network demand associated with the automated feed retrieval system.

15. The computer program product of claim 13, wherein the computer usable code, if executed, causes a computer to delete a feed handler plug-in associated with the feed source.

16. The computer program product of claim 11, wherein the computer usable code, if executed, causes a computer to re-subscribe a user from the feed source if a confirmation response to the re-subscription prompt is received from the user.

17. The computer program product of claim 11, wherein the computer usable code, if executed, causes a computer to:
identify a last access date associated with the feed source; and
compare the last access date to a current date to determine the inactivity period.

18. The computer program product of claim 11, wherein the computer usable code, if executed, causes a computer to access a user profile to identify the user time-out threshold.

19. The computer program product of claim 11, wherein the computer usable code, if executed, causes a computer to:
aggregate data from a plurality of feed sources; and
populate one or more feed aggregator containers with the aggregated data.

20. The computer program product of claim 19, wherein the computer usable code, if executed, causes a computer to aggregate the data from the plurality of feed sources via a network connection.
